(19) United States
(12) Patent Application Publication
(10) Pub. No.: US 2015/0207133 A1
(43) Pub. Date: Jul. 23, 2015

(54) BATTERY HAVING A THERMAL SWITCH

(71) Applicant: VOLKSWAGEN VARTA Microbattery Forschungsgesellschaft mbH & Co. KG, Ellwangen Jagst (DE)

(72) Inventors: Konrad Holl, Aalen (DE); Werner Schreiber, Meine (DE); Markus Pompetzki, Ellwangen (DE); Stefan Stock, Rainau (DE); Steffen Legner, Ellwangen (DE); Andreas Gaugler, Ellwangen (DE)

(21) Appl. No.: 14/416,082

(22) PCT Filed: Jul. 25, 2013
(86) PCT No.: PCT/EP2013/065740

§ 371 Date: Jan. 21, 2015

(30) Foreign Application Priority Data
Jul. 25, 2012 (DE) 10 2012 213 100.0

(51) Int. Cl. H01M 2/34; H01M 10/48; H01M 10/42

(52) U.S. Cl. CPC H01M 2/345; H01M 10/4235; H01M 10/48; H01M 2/348; H01M 10/637; H01M 2200/20; H01M 2200/103; H01M 2200/101

(57) ABSTRACT

A battery includes a housing, at least one individual cell with at least one positive and at least one negative electrode arranged in the housing, a positive tap pole connected to the at least one positive electrode, and a negative tap pole connected to the at least one negative electrode. The battery also includes at least one thermal switch which, in the event of an increase in temperature within the housing beyond a temperature threshold value, changes its switching state as a result of a temperature-induced expansion and/or deformation and trips a safety mechanism which suppresses a further increase in temperature.

### TECHNICAL FIELD

This disclosure relates to a battery having a housing, having at least one individual cell with at least one positive and at least one negative electrode, the individual cell arranged in the housing, having a positive tap pole connected to the at least one positive electrode and a negative tap pole connected to the at least one negative electrode, and also to a method for the safe operation of a battery of this kind.

### BACKGROUND

The term “battery” originally meant a plurality of electrochemical cells connected in series. However, single electrochemical cells (individual cells) are nowadays frequently also referred to as batteries. During the discharge of an electrochemical cell, an energy-supplying chemical reaction made up of two electrically coupled but physically separate partial reactions takes place. In an oxidation process, electrons are liberated at the negative electrode, resulting in a flow of electrons via an external load to the positive electrode which takes up a corresponding quantity of electrons. A reduction process therefore takes place at the positive electrode. At the same time, an ion current corresponding to the electrode reaction occurs within the cell. This ion current is ensured by an ionically conductive electrolyte. In secondary cells and batteries, this discharge reaction is reversible. It is therefore possible to reverse the transformation of chemical energy into electrical energy which occurs during discharge.

From among the known secondary cells, comparatively high energy densities are achieved by lithium-ion cells in particular, that is to say by cells in which lithium ions migrate from one electrode to the other during charging and discharging processes. Cells of this kind are particularly suitable for use in portable devices such as Notebooks and mobile telephones. However, they are also of particular interest as energy sources for motor vehicles.

In general, the cells of lithium-ion batteries have combustible components, for example, the electrolyte of a lithium-ion cell often comprises an organic solvent such as ethylene carbonate, for example, as the main component. In conjunction with the high energy density of cells of this kind, this represents a potential hazard which should not be underestimated. Special safety precautions must accordingly be taken to be able to preclude risks for the user or to keep the risks as minor as possible.

Lithium-ion cells may enter a critical state, in which there is a risk of fire among other things, particularly when they are mechanically damaged or as a result of being excessively charged. Excessive charging of a lithium-ion cell can lead to deposition of metallic lithium on the surface of the negative electrode and also to destruction of the electrolyte contained in the cell. The latter may lead to severe gassing of the cell. In extreme cases, this may lead to damage to the housing which surrounds the cell. As a result, moisture and oxygen can enter the cell, and this can result in explosion-like combustion.

It is known to provide lithium-ion cells with safety means to avoid this problem. A suitable circuit arrangement to electronically monitor the operational safety of rechargeable lithium-ion cells is known, for example, from DE 101 04 981 A1. The use of fuses to increase the safety of lithium-ion batteries is known from DE 10 2008 020 912 A1. DE 10 2007 020 905 A1 discloses cells having a discharge conductor arranged on a thin plastic film and having a predetermined breaking point. If the film deforms, for example, as a result of cell gassing, the discharge conductor is destroyed at the predetermined breaking point, as a result of which the cell is irreversibly and permanently deactivated.

It could therefore be helpful to provide batteries, in particular lithium-ion batteries, in which a reliable and simple safety solution is realized.

### SUMMARY

We provide a battery including a housing, at least one individual cell with at least one positive and at least one negative electrode arranged in the housing, a positive tap pole connect6ed to the at least one positive electrode, a negative tap pole connected to the at least one negative electrode, at least one thermal switch which, in the event of an increase in temperature wi8thin the housing beyond a temperature threshold value, changes its switching state as a result of a temperature-induced expansion and/or deformation and trips a safety mechanism which suppresses a further increase in temperature, and at least one pneumatically operable electrical switch which, in the event of an increase in pressure within the housing beyond a pressure threshold value, changes its switching state and trips a safety mechanism which suppresses a further increase in pressure.

We also provide a battery including a housing, at least one individual cell with at least one positive and at least one negative electrode arranged in the housing, a positive tap pole connected to the at least one positive electrode, a negative tap pole connected to the at least one negative electrode, at least one thermal switch which, in the event of an increase in temperature within the housing beyond a temperature threshold value, changes its switching state as a result of a temperature-induced expansion and/or deformation and trips a safety mechanism which suppresses a further increase in temperature, and at least one pneumatically operable electrical switch which, in the event of an increase in pressure within the housing beyond a pressure threshold value, changes its switching state and trips a safety mechanism which suppresses a further increase in pressure, wherein the at least one thermal switch and the at least one pneumatically operable electrical switch are arranged such that, when the safety mechanism which suppresses the further increase in temperature is tripped, they can interact such that the safety mechanism is tripped more rapidly.

### BRIEF DESCRIPTION OF THE DRAWINGS

FIG. 1 is a schematic cross-sectional view of one example of one of our batteries.

FIG. 2 is a schematic cross-sectional view of another example of one of our batteries.

FIG. 3 is a schematic cross-sectional view of yet another one example of one of our batteries.

### DETAILED DESCRIPTION

Our batteries comprise at least one individual cell with at least one positive and at least one negative electrode. The individual cell is preferably a lithium-ion-based cell. Accordingly, the battery is preferably a lithium-ion battery. Fields of application for the battery are found, in particular, in the motor vehicle sector. The battery is accordingly preferably a motor vehicle battery.

The individual cell is preferably in the form of a composite comprising electrode foils and separator sheets in the sequence positive electrode/separator/negative electrode. The electrodes preferably comprise metallic current collectors usually in the form of sheet-like structures. In lithium-ion batteries, a mesh or a foil composed of aluminum, for example, of expanded aluminum metal or a perforated aluminum foil, is preferably located approximately on the side of the positive electrode. Meshes or foils composed of copper are usually used as current collectors on the side of the negative electrode. In principle, the battery can contain both a cell stack (stack) comprising a plurality of flat individual cells, and also a wound individual cell (coil).

The at least one individual cell is arranged in a housing. The housing shields the at least one individual cell from its surroundings and is preferably gas- and liquid-tight.

The battery has a positive tap pole connected to the at least one positive electrode, and a negative tap pole connected to the at least one negative electrode. The tap poles serve for connection of an electrical load, that is to say electrical energy stored in the battery is “tapped off” at the tap poles.

The battery is particularly distinguished in that it comprises at least one thermal switch which, in the event of an increase in temperature within the housing beyond a temperature threshold value, changes its switching state as a result of a temperature-induced expansion and/or deformation and in the process trips a safety mechanism which suppresses a further increase in temperature.

Preferably, the thermal switch is a thermal bimetallic switch having a thermal bimetallic element which deforms, in particular bends, when it is heated.

Further preferably, the thermal switch is a thermal expansion switch comprising an expansion element which expands in at least one direction when it is heated.

The thermal bimetallic switch and the thermal expansion switch each connect two electrical contacts physically separate from one another at a temperature below the threshold value. In the thermal bimetallic switch, the thermal bimetallic element deforms in the event of an increase in temperature beyond the temperature threshold value, until it contacts the two contacts at the same time. In the thermal expansion switch, the expansion element expands until it contacts the two contacts at the same time or it presses the two contacts together as a result of its expansion.

As is known, a thermal bimetallic element (bimetallic element for short) is a metal strip comprising metal layers having a different coefficient of thermal expansion. In the event of a change in temperature, the metal layers expand to different degrees, this leading to the metal strip bending. Examples of suitable combinations of metals include zinc/steel or steel/brass.

In general, the thermal bimetallic element fixedly connects to the first of the contacts to be connected, for example, by welding and is arranged in relation to the second contact such that it bends in the direction of the contact in the event of an increase in temperature. The choice of a suitable distance between the thermal bimetallic element and the second contact is one way of setting the temperature threshold value, the thermal bimetallic switch changing its switching state when the temperature threshold value is exceeded.

The expansion element of the thermal expansion switch is preferably composed of a material with a high coefficient of thermal expansion. The expansion element may be a solid, but also a liquid or a gas which may preferably be arranged in an expandable, liquid-tight and/or gas-tight casing.

If the expansion element is composed of an electrically conductive material, it may be arranged between the electrical contacts to be connected so that it makes contact with the contacts at the same time in the event of expansion, or the expansion element connects to the first contact to be connected, for example, by welding and is arranged in relation to the second contact such that it expands in the direction of the contact until it touches the contact in the event of an increase in temperature. The choice of a suitable distance between the expansion element and the second contact is one way of setting the temperature threshold value, the thermal expansion switch changing its switching state when the temperature threshold value is exceeded.

However, it is generally easier to use expansion in the event of heating to press two electrical contacts arranged at a defined distance from one another against one another, for example, by a movably mounted contact spring pressed against a stationary contact by the expansion element. The expansion element itself does not have to be electrically conductive for this purpose.

Therefore, use is made of the change in temperature of a battery or the cells contained therein, the change in temperature often being associated with excessive charging. An increasing temperature leads to bending of the thermal bimetallic element or to expansion of the expansion element in at least one direction and therefore to the thermal switch being closed as a result of which the safety mechanism is tripped.

Preferably, at least one of the tap poles, preferably both of the tap poles, is a pole in the form of a metallic rod or bolt routed from the outside, through the housing of the battery and into the housing interior. The pole is generally electrically and mechanically separated from the housing by an insulating compound, as described, for example, in DE 100 47 206 A1. If both poles are insulated in this way, the housing is free of potential.

However, in principle, it is also entirely possible for the housing itself to serve as a positive or negative tap pole. To this end, the housing has to be electrically conductive. However, it is preferably composed of metal, in particular aluminum or an aluminum alloy, in any case or is provided with a metal coating.

It may also be preferred for at least one of the tap poles, possibly also for both tap poles, to be arranged on the outside of the housing and to not directly electrically connect to the at least one positive electrode or to the at least one negative electrode, but rather to connect by a separate contact pole. The contact pole is preferably in the form of a rod or bolt routed through the housing of the battery into the interior of the housing. The at least one tap pole may serve to electrically contact the battery while the contact pole ensures the electrical connection to the electrode or electrodes. The contact pole is preferably also electrically and mechanically separated from the housing as described in DE 100 47 206 A1 which has already been mentioned. The at least one tap pole may be electrically insulated from the housing, but electrically connected to the contact pole by a corresponding conductor.

Particularly preferably, the at least one thermal switch connects the positive tap pole and/or contact pole to the negative tap pole and/or contact pole when it is closed. Therefore, when it is closed, the switch connects either
a housing, which serves as a tap pole, to a tap pole and/or contact pole of opposite polarity or
the positive tap pole and/or contact pole to the negative tap pole and/or contact pole.

In the latter case, the poles either directly connect or connect by an interposed conductor. The housing can also serve as the interposed conductor.

It may be preferred for the battery to comprise, in addition to the at least one thermal switch, at least one pneumatically operable electrical switch which, in the event of an increase in pressure within the housing beyond a pressure threshold value, changes its switching state and in the process trips a safety mechanism which suppresses a further increase in pressure.

The at least one pneumatically operable electrical switch preferably comprises two electrical contacts physically separated from one another at a pressure below the pressure threshold value. Furthermore, the switch preferably comprises a gas-impermeable diaphragm which forms a boundary layer between the interior of the housing and the area surrounding the housing. The diaphragm should ideally be elastically deformable by the pressure. A suitable diaphragm is, for example, a plastic film or a metal foil. In the event of an increase in pressure within the housing, a diaphragm of this kind curves outward. The diaphragm and the electrical contacts are arranged such that the two electrical contacts connect to one another when the pressure exceeds the pressure threshold value. Owing to the increase in pressure, the switch therefore changes its switching state. The switch may be closed as a result of the outward curvature generated by the pressure. To this end, one of the contacts, for example, can be fixedly coupled to the outside of the diaphragm, while the other is arranged above the diaphragm so that the contacts can make contact when the diaphragm curves outward.

In the process, use is therefore made of the gassing of a cell which occurs in the event of excessive charging. The produced gases serve as a “working medium” as part of the cell safety mechanism and can exert pressure on the diaphragm so that the diaphragm curves outward. The curvature then in turn results in the switch being mechanically closed. Strictly speaking, the switch is therefore a “pneumatic electromechanical switch.”

The at least one thermal switch and the pneumatic electromechanical switch are preferably arranged such that they can interact when the safety mechanism which suppresses the further increase in temperature is tripped. To this end, a thermal bimetallic element, for example, may be arranged above a diaphragm, which is incorporated in the housing, of the pneumatic electromechanical switch so that a contact arranged on the outside of the diaphragm can contact the thermal bimetallic element when the diaphragm curves outward in the event of an increase in pressure. If, at the same time, the thermal bimetallic element is heated, the thermal bimetallic element bends in the direction of the housing and in this way reduces the distance from the contact which is arranged on the diaphragm. The safety mechanism is tripped more rapidly.

Preferably, a voltmeter and/or a load resistor connect between the positive tap pole and/or contact pole and the negative tap pole and/or contact pole.

When the load resistor connects between the poles, the battery may be discharged via the load resistor when the positive tap pole and/or contact pole electrically connects to the negative tap pole and/or contact pole by the at least one thermal switch and/or the at least one pneumatically operable electrical switch closing. Discharging of this kind prevents an increase in voltage within the cell and therefore possibly also a further increase in temperature and/or pressure within the housing.

When the voltmeter connects between the poles, the voltmeter can detect any existing overvoltage between the tap poles and/or contact poles. The measured voltage can be transmitted to a battery management system by which countermeasures can be initiated, for example, deliberate discharging of the cell via a separate electrical circuit or electronic uncoupling of the cell.

If, in contrast, neither an intermediate resistor nor a voltmeter is arranged between the tap poles, closing of the switch causes a short circuit. This may also be deliberate.

The battery particularly preferably has at least one fuse which, when it melts, interrupts the contact between the at least one positive electrode and the positive tap pole and/or between the at least one negative electrode and the negative tap pole. The fuse is preferably arranged on the outside of the housing, in particular between a contact pole and a tap pole electrically connected to the contact pole. The fuse is preferably selected such that it is not tripped during normal operation (that is to say, for example, during charging of the battery or during discharging with a useful load connected between the tap poles), however, melts in the case of a short circuit between the tap poles, as may be deliberately caused by the switch or switches. If the switch is closed in the event of an increase in temperature and/or pressure within the housing, the battery can be reliably deactivated by the fuse. Reactivation can be performed, if desired, by replacing the fuse.

Preferably, the battery has at least one high-value heating resistor thermally coupled to the at least one fuse and activated by the at least one thermal switch and/or the at least one pneumatically operable electrical switch when there is an increase in temperature and/or pressure within the housing beyond the respective threshold value.

To this end, the heating resistor can connect between the tap poles, for example, in place of the abovementioned load resistor. The heating resistor and the fuse are preferably matched to one another such that the fuse can trip only when the heating resistor is activated.

We also provide a method for the safe operation of a battery which has at least one individual cell with at least one positive and at least one negative electrode, and also to a housing in which the at least one individual cell is arranged.

In the method, any possible increase in temperature within the housing is detected by the at least one thermal switch. The thermal switch changes its switching state when a temperature threshold value is exceeded and in the process trips a safety mechanism which suppresses a further increase in temperature as a result of a temperature-induced expansion and/or deformation.

In addition, provision may be made for any possible increase in pressure within the housing to be detected in parallel by the described pneumatically operable electrical switch. When the pneumatically operable electrical switch changes its switching state as a result of the pressure threshold value being exceeded, a safety mechanism which suppresses a further increase in pressure is tripped.

Preferred variants, as can be tripped by the safety mechanism, have already been described. Within the scope of the method, the most preferred variant is that according to which the switch or switches electrically connects or connect the positive tap pole to the negative tap pole so that an electrical short circuit is created between the poles.

Further features and also resulting advantages can be found in the following description of the drawings which are used to illustrate our batteries and methods. It should be emphasized at this point that all of the optional aspects of the method described herein can be realized one the one hand on their own but, on the other, also in combination with one or more further features. The preferred examples described below serve merely to illustrate and better explain the batteries and methods and are not to be understood to be limiting in any way.

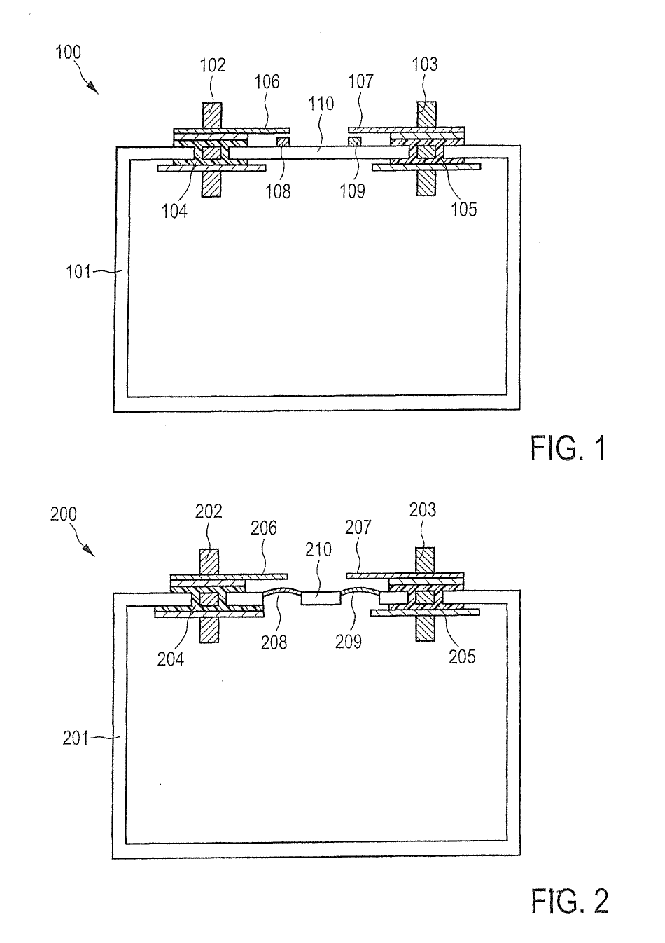

FIG. 1 schematically illustrates a battery 100. The battery has a housing 101 in which at least one individual cell with at least one positive and at least one negative electrode is arranged. The housing comprises a metal sheet. The at least one individual cell is not illustrated for reasons of clarity. The only important factor is that the at least one negative electrode is welded to the negative pole 102 of pin-like design. The at least one positive electrode electrically connects to the likewise pin-like positive pole 103. The two poles 102 and 103 are routed from the outside, through the housing 101, into the interior of the cell, but are insulated from the housing 101 by the insulating compounds 104 and 105. The housing 101 is accordingly free of potential. An electrical load can connect to the poles 102 and 103 on the outside of the housing, the poles 102 and 103 being tap poles.

The thermal bimetallic elements 106 and 107 are welded to the poles 102 and 103. The thermal bimetallic elements are arranged such that they bend toward the housing 101 when they are heated. The conductive contacts 108 and 109 are in turn arranged on the housing surface. If the thermal bimetallic element 106 contacts the contact 108 and the thermal bimetallic element 106 contacts the contact 109 at the same time, current can flow between the poles 102 and 103 by of the housing part 110. The battery 101 can be fully discharged by the housing part 110 when the switch is closed.

The battery 200 illustrated in FIG. 2 is the same as the battery illustrated in FIG. 1 in almost all respects. For example, two poles 202 and 203 are also routed through a housing 201. The insulating compounds 204 and 205 physically and electrically separate the housing 201 and the poles 202 and 203 from one another. The thermal bimetallic elements 206 and 207 are welded to the poles 202 and 203. The thermal bimetallic elements are arranged such that they bend toward the housing 101 when heated.

However, the contact diaphragms 208 and 209 are incorporated into the housing. The contact diaphragms each comprise an electrically conductive metal composite foil and electrically conductively connect to the housing part 210.

If the thermal bimetallic elements 206 and 207 bend in the direction of the housing 101 as a result of being heated and the thermal bimetallic element 206 contacts the contact diaphragm 208 and the thermal bimetallic element 206 contacts the contact diaphragm 209 at the same time, a current can flow between the poles 102 and 103 by the housing part 210.

This mechanism can be assisted when gas pressure occurs in the interior of the housing 201. When the gas pressure in the interior of the housing 201 is high enough and the diaphragm 206 curves outwards, the distance between the contact diaphragm 208 and the thermal bimetallic element 206 reduces as a result.

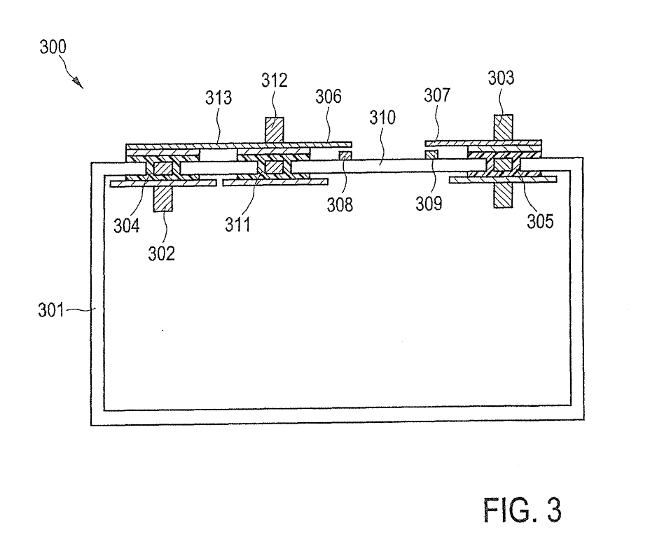

The example illustrated in FIG. 3 differs from the example illustrated in FIG. 1 in that the pole 302 passing through the housing 301 is not a tap pole, but rather a contact pole. The pole 312 arranged on the outside of the housing 301 and physically and electrically separated from the housing by the insulating compound 311 serves as the negative tap pole. The tap pole 312 and the contact pole 302 electrically connect to one another, specifically by the fuse 313. The fuse is a low-impedance fuse which allows electrical charging between the contact pole 302 and the tap pole 312 without a high level of resistance. If, however, a short circuit is caused by the thermal bimetallic elements 306 and 307 (as a result of the thermal bimetallic elements being heated) and also the contacts 308 and 309 and also the housing part 310, the fuse 313 is tripped. Since the fuse 313 is arranged on the outside of the housing 301, it can be easily replaced as required.

1-10. (canceled)

11. A battery comprising:
a housing;
at least one individual cell with at least one positive and at least one negative electrode arranged in the housing;
a positive tap pole connected to the at least one positive electrode;
a negative tap pole connected to the at least one negative electrode;
at least one thermal switch which, in the event of an increase in temperature within the housing beyond a temperature threshold value, changes its switching state as a result of a temperature-induced expansion and/or deformation and trips a safety mechanism which suppresses a further increase in temperature; and
at least one pneumatically operable electrical switch which, in the event of an increase in pressure within the housing beyond a pressure threshold value, changes its switching state and trips a safety mechanism which suppresses a further increase in pressure.

12. The battery as claimed in claim 11, wherein the thermal switch is a thermal bimetallic switch having a thermal bimetallic element which bends when heated.

13. The battery as claimed in claim 11, wherein that the thermal switch is a thermal expansion switch which comprises an element which expands in at least one direction when heated.

14. The battery as claimed in claim 11, wherein at least one of the tap poles is arranged outside of the housing and connects to the at least one positive electrode or to the at least one negative electrode by a separate contact pole routed through the housing.

15. The battery as claimed in claim 11, wherein the at least one thermal switch electrically connects the positive tap pole and/or contact pole to the negative tap pole and/or contact pole and creates an electrical short circuit between the poles when closed.

16. The battery as claimed in claim 11, further comprising a voltmeter and/or a load resistor connected between the positive tap pole and/or contact pole and the negative tap pole and/or contact pole.

17. The battery as claimed in claim 11, further comprising at least one fuse which, when it melts, interrupts the contact between the at least one positive electrode and the positive tap pole and/or between the at least one negative electrode and the negative tap pole.

18. The battery as claimed in claim 17, wherein the fuse is arranged outside of the housing between a contact pole and a tap pole electrically connected to said contact pole.

19. The battery as claimed in claim 17, further comprising at least one high-value heating resistor thermally coupled to the at least one fuse and activated by the at least one thermal switch and/or the at least one pneumatically operable electrical switch when there is an increase in temperature and/or pressure within the housing beyond the respective threshold value.

20. A battery comprising:
a housing;
at least one individual cell with at least one positive and at least one negative electrode arranged in the housing;
a positive tap pole connected to the at least one positive electrode;
a negative tap pole connected to the at least one negative electrode;
at least one thermal switch which, in the event of an increase in temperature within the housing beyond a temperature threshold value, changes its switching state as a result of a temperature-induced expansion and/or deformation and trips a safety mechanism which suppresses a further increase in temperature; and
at least one pneumatically operable electrical switch which, in the event of an increase in pressure within the housing beyond a pressure threshold value, changes its switching state and trips a safety mechanism which suppresses a further increase in pressure, wherein the at least one thermal switch and the at least one pneumatically operable electrical switch are arranged such that, when the safety mechanism which suppresses the further increase in temperature is tripped, they can interact such that the safety mechanism is tripped more rapidly.
